(19) United States
(12) Patent Application Publication
(10) Pub. No.: US 2015/0193654 A1
(43) Pub. Date: Jul. 9, 2015

(54) EVALUATION METHOD, EVALUATION APPARATUS, AND RECORDING MEDIUM

(71) Applicant: FUJITSU LIMITED, Kawasaki-shi (JP)

(72) Inventors: Miho Sakai, Yokohama (JP); Atsushi Oguchi, Kawasaki (JP)

(73) Assignee: Fujitsu Limited, Kawasaki (JP)

(21) Appl. No.: 14/573,730

(22) Filed: Dec. 17, 2014

(30) Foreign Application Priority Data
Jan. 7, 2014 (JP) 2014-001253

(51) Int. Cl. G06K 9/00; G06K 9/62

(52) U.S. Cl. CPC G06K 9/00342; G06K 9/00624; G06K 9/6267

(57) ABSTRACT

A non-transitory computer-readable recording medium has stored therein a program that causes a computer to execute an evaluation process including: acquiring a beat or a timing at which a person included in a plurality of captured images obtained by sequential image capturing takes a beat, motion or timing being extracted from the plurality of captured images; and outputting an evaluation on a tempo of a motion of the person based on a comparison of a tempo indicated by the acquired beat or the acquired timing with a reference tempo.

### CROSS-REFERENCE TO RELATED APPLICATION

This application is based upon and claims the benefit of priority of the prior Japanese Patent Application No. 2014-001253, filed on Jan. 7, 2014, the entire contents of which are incorporated herein by reference.

### FIELD

The embodiments discussed herein are related to an evaluation program, an evaluation method, and an evaluation apparatus.

### BACKGROUND

There have been developed technologies for scoring a dance of a person and notifying the person of the scoring result.

Examples of the technologies for scoring and evaluating a dance of a person may include a technology for evaluating a game play of a player performing a game in which the player moves a part of the body to music. The technology makes an evaluation based on a determination result of whether, after a part of the player moves at a speed equal to or higher than a reference speed, the part continues to substantially stop for a reference period, for example.

Japanese Laid-open Patent Publication No. 2013-154125

To score or evaluate a dance of a person, it is requested to extract a timing at which the person takes a rhythm, that is, a motion or a timing at which the person takes a beat. The technology described above, however, may possibly fail to easily extract a motion or a timing at which a person takes a beat because of a large amount of processing for an analysis. Thus, the technology may possibly fail to easily evaluate a tempo of a motion of the person.

In an aspect, a dance of a person is scored by capturing a motion of the person with a camera, analyzing a moving image obtained by the capturing with a computer, and extracting a rhythm of the person, for example. In a specific method, for example, a part of the face and the body of the person or an instrument used by the person, such as maracas, are recognized from the moving image by a predetermined recognition technology, such as template matching. This generates time-series data of a moving amount of the recognized part of the face and the body or the recognized instrument. Subsequently, a Fourier analysis or the like is performed on the time-series data, thereby extracting a rhythm of the person from components in a specific frequency band. By comparing the extracted rhythm of the person with a reference rhythm, for example, the dance of the person may be scored based on the comparison result. In the case of using template matching to recognize a part of the face and the body of the person or an instrument used by the person, such as maracas, from the moving image in the aspect above, for example, comparison between a template and a part of the moving image is repeatedly performed. This increases the amount of processing for the analysis, thereby increasing processing load of the computer.

### SUMMARY

According to an aspect of the embodiments, a non-transitory computer-readable recording medium has stored therein a program that causes a computer to execute an evaluation process including: acquiring a beat or a timing at which a person included in a plurality of captured images obtained by sequential image capturing takes a beat, motion or timing being extracted from the plurality of captured images; and outputting an evaluation on a tempo of a motion of the person based on a comparison of a tempo indicated by the acquired beat or the acquired timing with a reference tempo.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example block diagram of a configuration of an evaluation apparatus according to a first embodiment;

FIG. 2 is an example diagram of a frame;

FIG. 3 is an example diagram of timing data;

FIG. 4 is an example diagram of a binarized image;

FIG. 5 is an example diagram of association between a background difference amount and a frame number;

FIG. 6 is an example diagram for explaining processing performed by the evaluation apparatus according to the first embodiment;

FIG. 7 is an example diagram of a graph obtained by plotting a timing at which a person takes a beat indicated by the timing data;

FIG. 8 is an example diagram of a method for comparing timings in the case of using the timing at which the person takes a beat as a reference;

FIG. 9 is an example diagram of a method for comparing timings in the case of using a timing of a beat in a reference tempo as a reference;

FIG. 10 is a flowchart of evaluation processing according to the first embodiment;

FIG. 11 is an example block diagram of a configuration of an evaluation apparatus according to a second embodiment;

FIG. 12 is an example diagram of a method for comparing the number of timings;

FIG. 13 is an example block diagram of a configuration of an evaluation apparatus according to a third embodiment;

FIG. 14 is an example diagram of a method for comparing characteristics of a motion of the person and characteristics of a melody;

FIG. 15 is an example diagram of a system in a case where the evaluation apparatus operates in conjunction with a karaoke machine;

FIG. 16 is an example diagram of a system including a server; and

FIG. 17 is a diagram of a computer that executes an evaluation program.

### DESCRIPTION OF EMBODIMENTS

Preferred embodiments will be explained with reference to accompanying drawings. The embodiments are not intended to limit the disclosed technology and may be optionally combined as long as no inconsistency arises in processing contents.

### [a] First Embodiment

### Example of a Functional Configuration of an Evaluation Apparatus 10 According to a First Embodiment

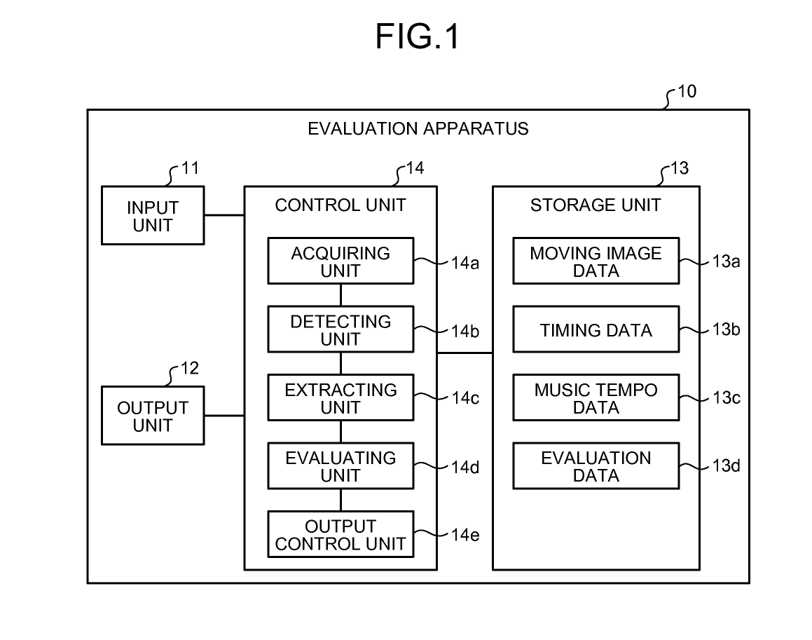

An evaluation apparatus 10 illustrated in an example in FIG. 1 extracts, from each frame of a moving image obtained by capturing a person who is dancing with a camera, a timing at which a motion amount of the person temporarily decreases as a timing at which the person takes a rhythm, that is, a timing at which the person takes a beat. Thus, the timing at which a motion amount of the person temporarily decreases is extracted as a timing at which the person takes a beat. This is because a person temporarily stops a motion when taking a beat, whereby the motion amount temporarily decreases. A rhythm means regularity of intervals of a tempo, for example. A tempo means a length of an interval between beats, for example. The evaluation apparatus 10 compares a tempo indicated by the extracted timing and a reference tempo serving as a reference, thereby evaluating a tempo of a motion of the person. As described above, the evaluation apparatus 10 extracts a timing at which a person takes a beat, thereby evaluating a tempo of a motion of the person without performing recognition processing for recognizing a part of the face and the body of the person or an instrument, that is, recognition processing requiring a large amount of processing (high processing load). Therefore, the evaluation apparatus 10 can facilitate evaluating the tempo of the motion of the person.

FIG. 1 is an example block diagram of a configuration of the evaluation apparatus according to the first embodiment. As illustrated in the example in FIG. 1, the evaluation apparatus 10 includes an input unit 11, an output unit 12, a storage unit 13, and a control unit 14.

The input unit 11 inputs various types of information to the control unit 14. When the input unit 11 receives an instruction to perform evaluation processing, which will be described later, from a user who uses the evaluation apparatus 10, for example, the input unit 11 inputs the received instruction to the control unit 14. Examples of a device of the input unit 11 may include a mouse, a keyboard, and a network card that receives various types of information transmitted from other devices (not illustrated) and inputs the received information to the control unit 14.

The output unit 12 outputs various types of information. When the output unit 12 receives an evaluation result of a tempo of a motion of a person from an output control unit 14e, which will be described later, the output unit 12 displays the received evaluation result or transmits the received evaluation result to a mobile terminal of the user or an external monitor, for example. Examples of a device of the output unit 12 may include a monitor and a network card that transmits various types of information transmitted from the control unit 14 to other devices (not illustrated).

The storage unit 13 stores therein various type of information. The storage unit 13 stores therein moving image data 13a, timing data 13b, music tempo data 13c, and evaluation data 13d, for example.

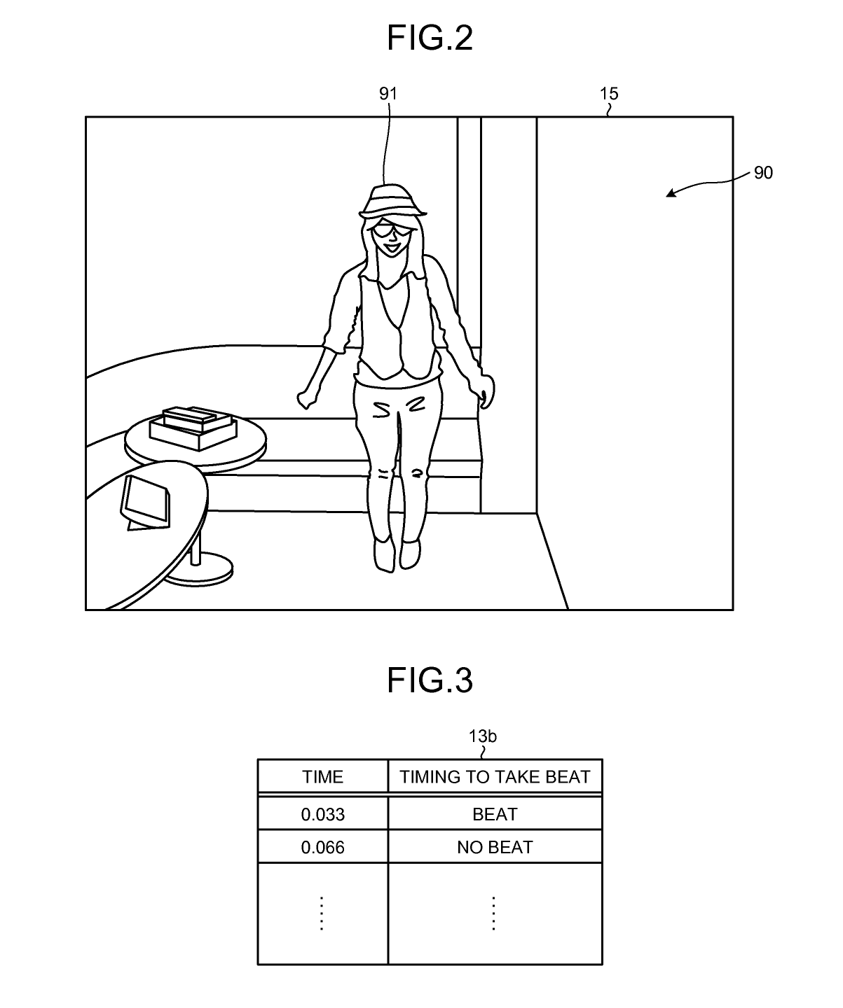

The moving image data 13a is data of a moving image including a plurality of frames obtained by capturing a person who is dancing with a camera. Examples of the person may include a person who is singing a song to music reproduced by a karaoke machine and dancing to the reproduced music in a karaoke box. The frames included in the moving image data 13a are obtained by sequential image capturing with the camera and are an example of a captured image. FIG. 2 is an example diagram of a frame. In the example in FIG. 2, a frame 15 includes a person 91 who is singing a song and dancing to music in a karaoke box 90. The frame rate of the moving image data 13a may be set to a desired value. In the description below, the frame rate is set to 30 frames per second (fps).

The timing data 13b indicates time (timing) at which a person who is dancing takes a beat (to take a beat). In a case where the person included in the moving image data 13a is a person who is singing a song and dancing to reproduced music in a karaoke box, examples of the time may include time from the start of the music and the dance. This is because the dance is started simultaneously with the start of the music. FIG. 3 is an example diagram of timing data. The timing data 13b illustrated in the example in FIG. 3 includes items of “time” and “timing to take a beat”. In the item “time”, time from the start of the music and the dance is registered by an extracting unit 14c, which will be described later. In the item “timing to take a beat”, “beat” is registered by the extracting unit 14c, which will be described later, in a case where the time registered in the item “time” is a timing at which the person takes a beat, whereas “no beat” is registered in a case where the time is not a timing at which the person takes a beat. In the first record of the timing data 13b illustrated in the example in FIG. 3, time of “0.033” second after the start of the music and the dance is associated with “beat” registered in the item “timing to take a beat”. This indicates that the time is a timing at which the person takes a beat. In the second record of the timing data 13b illustrated in the example in FIG. 3, time of “0.066” second after the start of the music and the dance is associated with “no beat” registered in the item “timing to take a beat”. This indicates that the time is not a timing at which the person takes a beat.

The music tempo data 13c indicates a reference tempo. The reference tempo is acquired from sound information by an evaluating unit 14d, which will be described later. Examples of the sound information may include a sound collected by a microphone (not illustrated), music reproduced by a karaoke machine, audio data acquired in association with the moving image data 13a from video data recorded with a video camera or the like (not illustrated), and musical instrument digital interface (MIDI).

The evaluation data 13d indicates an evaluation result of a tempo of a motion of a person evaluated by the evaluating unit 14d, which will be described later. The evaluation result will be described later.

The storage unit 13 is a semiconductor memory device such as a flash memory or a storage device such as a hard disk and an optical disk, for example.

The control unit 14 includes an internal memory that stores therein a computer program and control data specifying various types of processing procedures. The control unit 14 performs various types of processing with these data. As illustrated in FIG. 1, the control unit 14 includes an acquiring unit 14a, a detecting unit 14b, the extracting unit 14c, the evaluating unit 14d, and the output control unit 14e.

The acquiring unit 14a acquires a difference between a first frame and a second frame captured prior to the first frame for each of a plurality of frames included in a moving image indicated by the moving image data 13a. The acquiring unit 14a also acquires a difference between a first frame and a third frame obtained by accumulating frames captured prior to the first frame for each of the frames included in the moving image indicated by the moving image data 13a.

An aspect of the acquiring unit 14a will be described. When the input unit 11 inputs an instruction to perform evaluation processing, which will be described later, the acquiring unit 14a acquires the moving image data 13a stored in the storage unit 13, for example.

The acquiring unit 14a uses a background difference method, thereby acquiring a difference between a first frame and a second frame captured prior to the first frame for each of a plurality of frames included in a moving image indicated by the moving image data 13a. The acquiring unit 14a, for example, uses a known function to accumulate background statistics, thereby acquiring a difference between a first frame and a third frame obtained by accumulating frames captured prior to the first frame for each of the frames.

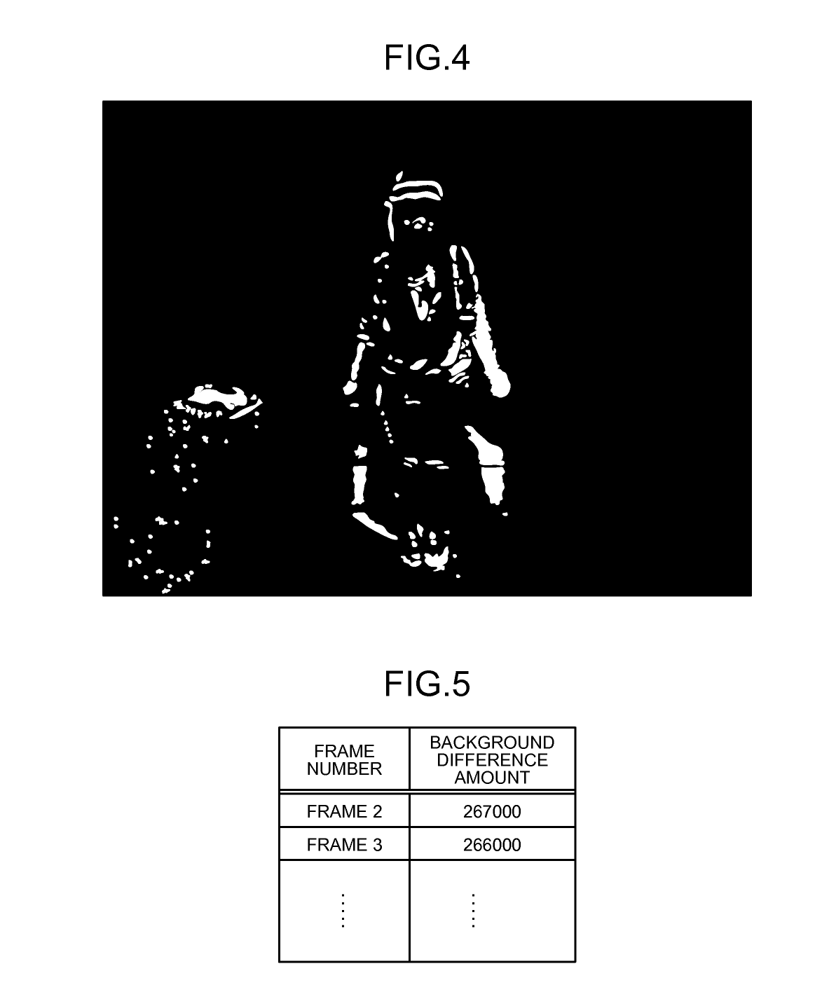

The following describes processing performed in a case where the acquiring unit 14a uses a function to accumulate background statistics. The acquiring unit 14a compares a frame with background information obtained from frames captured prior to the frame. The acquiring unit 14a generates a binarized image by determining a pixel with a change in luminance of equal to or lower than a threshold to be a black pixel and determining a pixel with a change in luminance of larger than the threshold to be a white pixel. The generated information is not limited to a binarized image composed of white and black pixels as long as it can be determined whether a change in luminance is equal to or lower than the threshold or larger than the threshold. FIG. 4 is an example diagram of a binarized image. The acquiring unit 14a, for example, uses the function to accumulate background statistics, thereby comparing a frame 15 illustrated in the example in FIG. 2 with background information obtained from frames captured prior to the frame 15. Thus, the acquiring unit 14a generates a binarized image illustrated in the example in FIG. 4. The acquiring unit 14a then calculates the total number of white pixels (background difference amount) included in the generated binarized image as a motion amount of the person. As described above, the present embodiment uses the background difference amount as an index indicating a moving amount of the person. The acquiring unit 14a, for example, calculates the total number of white pixels included in the binarized image illustrated in the example in FIG. 4 as a motion amount of the person 91. Thus, the acquiring unit 14a acquires the background difference amount as the motion amount of the person for each frame. The acquiring unit 14a then associates the background difference amount with a frame number for each frame. FIG. 5 is an example diagram of association between the background difference amount and the frame number. In the example in FIG. 5, the acquiring unit 14a associates a frame number “2” with a background difference amount “267000” and associates a frame number “3” with a background difference amount “266000”. Thus, the acquiring unit 14a acquires a difference between a first frame and a third frame obtained by accumulating frames captured prior to the first frame for each of the frames.

The acquiring unit 14a may use a code book method, thereby acquiring a difference between a first frame and a second frame captured prior to the first frame and a difference between the first frame and a third frame obtained by accumulating frames captured prior to the first frame.

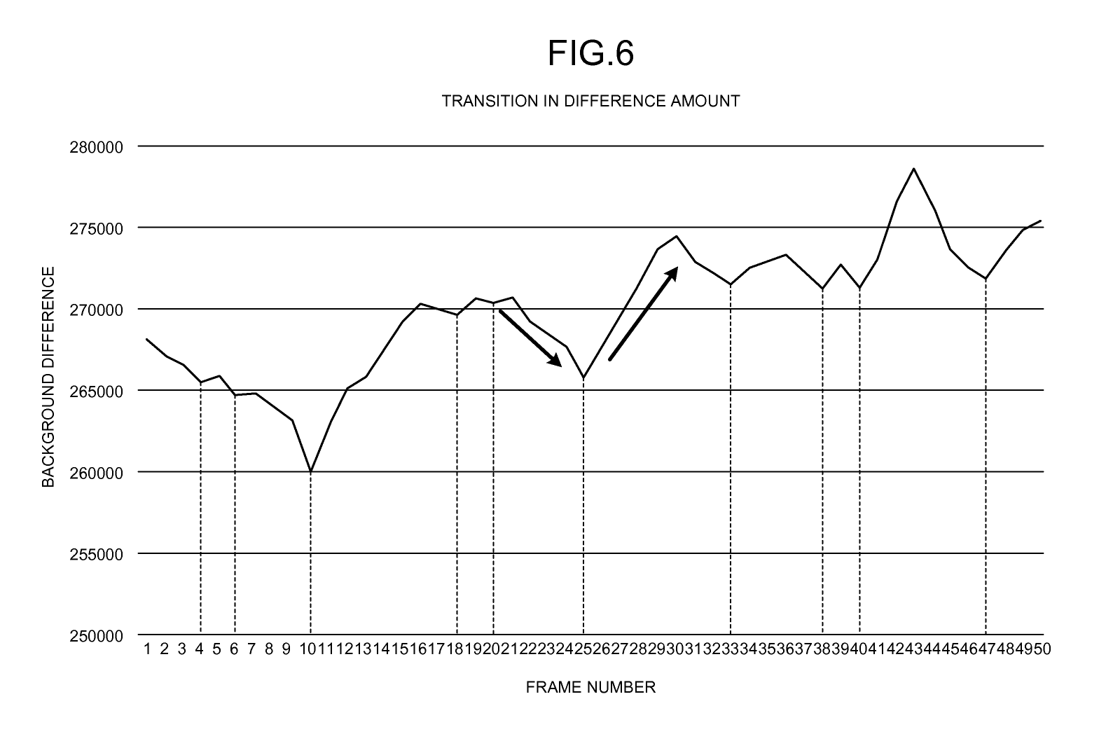

The detecting unit 14b detects a timing at which an amount of a temporal change in a plurality of frames obtained by sequential image capturing temporarily decreases. An aspect of the detecting unit 14b will be described. The detecting unit 14b, for example, uses the information in which the frame number and the background difference amount are associated with each other by the acquiring unit 14a. The detecting unit 14b detects a frame having a background difference amount smaller than that of a preceding frame and smaller than that of a following frame. FIG. 6 is an example diagram for explaining processing performed by the evaluation apparatus according to the first embodiment. FIG. 6 illustrates an example graph indicating the relation between the frame number and the background difference amount associated with each other by the acquiring unit 14a, where the abscissa indicates the frame number, and the ordinate indicates the background difference amount. The example graph in FIG. 6 illustrates the background difference amount of frames with a frame number of 1 to 50. In a case where the frame number and the background difference amount are associated with each other by the acquiring unit 14a as indicated by the example graph in FIG. 6, the detecting unit 14b performs the following processing. The detecting unit 14b detects the frame of the frame number “4” having a background difference amount smaller than that of the frame of the frame number “3” and smaller than that of the frame of the frame number “5”. Similarly, the detecting unit 14b detects the frames of the frame numbers “6”, “10”, “18”, “20”, “25”, “33”, “38”, “40”, and “47”.

The detecting unit 14b detects the time of capturing the detected frames as timings at which the amount of a temporal change in a plurality of frames temporarily decreases. The detecting unit 14b, for example, detects the time when the frames of the frame numbers “4”, “6”, “10”, “18”, “20”, “25”, “33”, “38”, “40”, and “47” are captured as timings at which the amount of a temporal change in a plurality of frames temporarily decreases.

The extracting unit 14c extracts a motion of taking a beat made by a person included in the frames or a timing at which the person takes a beat based on the timings detected by the detecting unit 14b.

An aspect of the extracting unit 14c will be described. The extracting unit 14c, for example, extracts the following timing from the timings detected by the detecting unit 14b. The extracting unit 14c extracts a frame satisfying predetermined conditions from the frames captured at the timings detected by the detecting unit 14b. The extracting unit 14c extracts the time of capturing the extracted frame as a timing at which the person included in the frames takes a beat.

The following describes an example of a method for extracting a frame satisfying the predetermined conditions performed by the extracting unit 14c. The extracting unit 14c, for example, selects each of the frames corresponding to the timings detected by the detecting unit 14b (frames captured at the detected timings) as an extraction candidate frame. Every time the extracting unit 14c extracts one extraction candidate frame, the extracting unit 14c performs the following processing. The extracting unit 14c determines whether the background difference amount decreases from a frame a predetermined number ahead of the extraction candidate frame to the extraction candidate frame and increases from the extraction candidate frame to a frame a predetermined number behind the extraction candidate frame. If the extracting unit 14c determines that the background difference amount decreases from the frame the predetermined number ahead of the extraction candidate frame to the extraction candidate frame and increases from the extraction candidate frame to the frame the predetermined number behind the extraction candidate frame, the extracting unit 14c performs the following processing. The extracting unit 14c extracts the time of capturing the extraction candidate frame as a timing at which the person included in the frames takes a beat. In other words, the extracting unit 14c extracts a motion of taking a beat made by the person included in the extraction candidate frame from the motions of the person indicated by the respective frames. The extracting unit 14c performs the processing described above on all the frames corresponding to the timings detected by the detecting unit 14b.

The following describes a case where the predetermined number is “4” and the frame number and the background difference amount are associated with each other by the acquiring unit 14a as illustrated in the example graph in FIG. 6. In this case, because the background difference amount decreases from the frame of the frame number “21” to the frame of the frame number “25” and increases from the frame of the frame number “25” to the frame of the frame number “29”, the extracting unit 14c performs the following processing. The extracting unit 14c extracts the time of capturing the frame of the frame number “25” as a timing at which the person included in the frames takes a beat. The extracting unit 14c also extracts a motion of taking a beat made by the person included in the frame of the frame number “25” from the motions of the person indicated by the respective frames. The predetermined number for the frame ahead of the extraction candidate frame and the predetermined number for the frame behind the extraction candidate frame may be set to difference values. In an aspect, the predetermined number for the frame ahead of the extraction candidate frame is set to “5”, and the predetermined number for the frame behind the extraction candidate frame is set to “1”, for example.

The extracting unit 14c registers time corresponding to a timing at which the person takes a beat out of the times of capturing the frames and “beat” in a manner associated with each other in the timing data 13b illustrated in FIG. 3. The extracting unit 14c also registers time not corresponding to a timing at which the person takes a beat out of the times of capturing the frames and “no beat” in a manner associated with each other in the timing data 13b illustrated in FIG. 3. Thus, the timing data 13b registers therein various types of information and is used to evaluate a rhythm of the person indicated by the timing at which the person takes a beat, for example. The extracting unit 14c registers time corresponding to a timing of taking a beat and “beat” in a manner associated with each other or time not corresponding to a timing of taking a beat and “no beat” in a manner associated with each other in the timing data 13b for all the frames. The extracting unit 14c then performs the following processing. The extracting unit 14c transmits registration information indicating that the extracting unit 14c registers the data relating to the timing of taking a beat of all the frames in the timing data 13b. The extracting unit 14c may transmit registration information indicating that the extracting unit 14c registers the data relating to the timing of taking a beat in the timing data 13b every time the extracting unit 14c registers time corresponding to a timing of taking a beat and “beat” in a manner associated with each other or time not corresponding to a timing of taking a beat and “no beat” in a manner associated with each other in the timing data 13b for one frame. In this case, the evaluating unit 14d, which will be described later, makes an evaluation in real time.

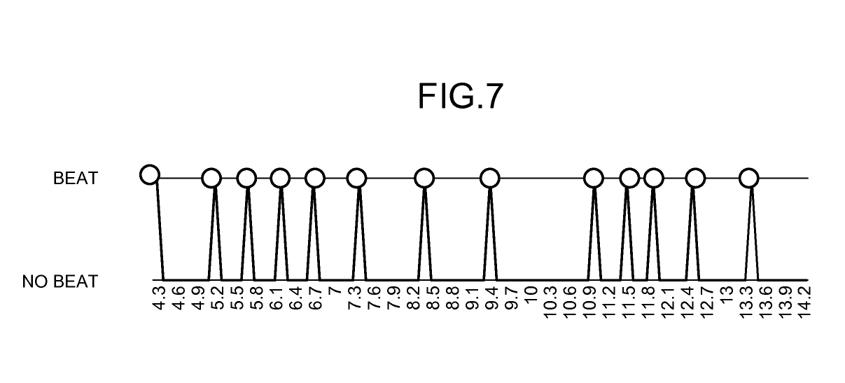

FIG. 7 is an example diagram of a graph obtained by plotting the timing at which the person takes a beat indicated by the timing data. In FIG. 7, the abscissa indicates time (second), and the ordinate indicates whether the person takes a beat. In the example in FIG. 7, whether it is a timing at which the person takes a beat is plotted at intervals of 0.3 second. In the example in FIG. 7, plotting is performed in every sequential nine frames as follows: a circle is plotted at a position of “beat” in a case where a timing at which the person takes a beat is present in timings at which the nine frames are captured; and no circle is plotted in a case where no timing at which the person takes a beat is present. In the example in FIG. 7, a circle is plotted at the position of “beat” correspondingly to time “4.3 seconds”. This indicates that a timing at which the person takes a beat is present in nine frames each corresponding to time of one-thirtieth second in the period from 4.0 seconds to 4.3 seconds. In the example in FIG. 7, no circle is plotted correspondingly to time “4.6 seconds”. This indicates that no timing at which the person takes a beat is present in nine frames each corresponding to time of one-thirtieth second in the period from 4.3 seconds to 4.6 seconds. The same applies to the other time. FIG. 7 conceptually illustrates an example of the timing data, and the timing data may be an appropriate aspect other than that illustrated in FIG. 7.

The evaluating unit 14d compares a tempo indicated by a motion of taking a beat made by a person included in a plurality of frames or a timing at which the person takes a beat, which is extracted from the frames, with a reference tempo, thereby evaluating the tempo of the motion of the person. Furthermore, the evaluating unit 14d evaluates the motion of the person based on a tempo extracted from a reproduced song (music) and on a timing at which the person takes a rhythm, which is acquired from frames including the person singing to the reproduced music as a capturing target.

An aspect of the evaluating unit 14d will be described. When the evaluating unit 14d receives registration information transmitted from the extracting unit 14c, the evaluating unit 14d acquires time of a timing at which the person takes a beat from the timing data 13b.

The evaluating unit 14d acquires a reference tempo from sound information. The evaluating unit 14d performs the following processing on sound information including audio of the person who is singing a song and dancing to reproduced music, which is collected by a microphone (not illustrated) in a karaoke box, and the reproduced music, for example. The evaluating unit 14d acquires a reference tempo using technologies, such as beat tracking and rhythm recognition. To perform beat tracking and rhythm recognition, several technologies may be used, including a technology described in a non-patent literature (“the Institute of Electronics, Information and Communication Engineers, “Knowledge Base”, Volume 2, Section 9, Chapter 2, 2-4, Audio Alignment, Beat Tracking, Rhythm Recognition” Online, Searched on Dec. 17, 2013, the URL http://www.ieice-hbkb.org/portal/doc_{—}557.html). Alternatively, the evaluating unit 14d may acquire the reference tempo from MIDI data corresponding to the reproduced music. The evaluating unit 14d stores the acquired reference tempo in the storage unit 13 as the music tempo data 13c.

The evaluating unit 14d compares a timing of a beat in the reference tempo indicated by the music tempo data 13c with a timing at which the person takes a beat acquired from the timing data 13b.

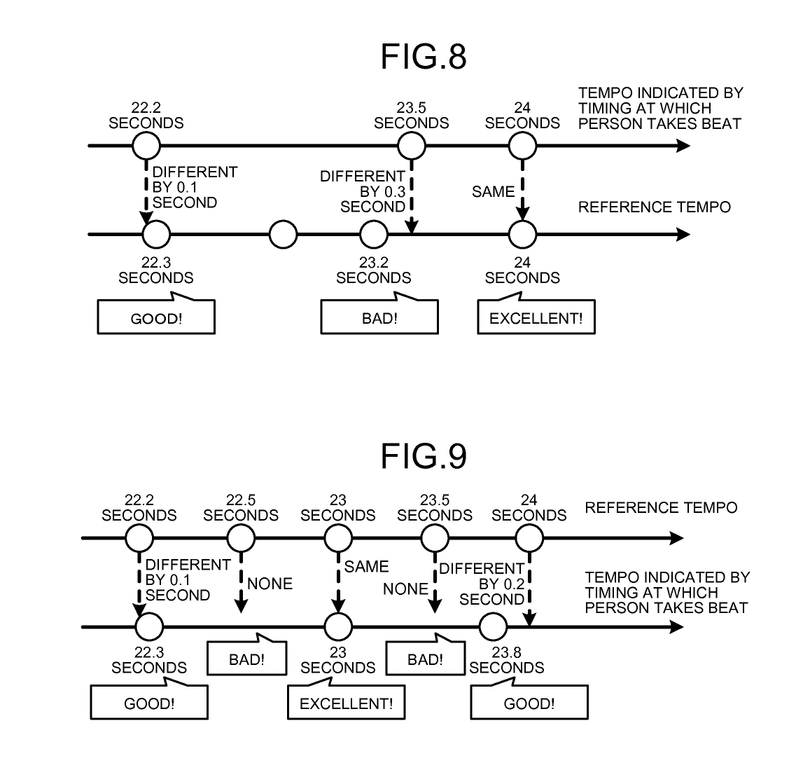

The evaluating unit 14d, for example, compares timings using the timing at which the person takes a beat as a reference. FIG. 8 is an example diagram of a method for comparing timings in the case of using the timing at which the person takes a beat as a reference. The example in FIG. 8 illustrates a tempo indicated by timings at which the person takes a beat and a reference tempo. In FIG. 8, circles on the upper line indicate timings at which the person takes a beat, whereas circles on the lower line indicate timings of a beat in the reference tempo. In the example in FIG. 8, the evaluating unit 14d calculates a difference between each of the timings at which the person takes a beat and a timing temporally closest thereto out of the timings of a beat in the reference tempo. The evaluating unit 14d then calculates points corresponding to the magnitude of the difference and adds the calculated points to a score. In a case where the difference is “0” second (a first threshold), for example, the evaluating unit 14d gives “Excellent!” and adds 2 to the score of evaluation. In a case where the difference is larger than “0” second and equal to or smaller than “0.2” second (a second threshold), the evaluating unit 14d gives “Good!” and adds 1 to the score of evaluation. In a case where the difference is larger than “0.2” second, the evaluating unit 14d gives “Bad!” and adds −1 to the score of evaluation. The evaluating unit 14d calculates the difference for all the timings at which the person takes a beat and adds points corresponding to the difference to the score. The score is set to 0 at the start of evaluation processing. The first threshold and the second threshold are not limited to the values described above and may be set to desired values.

In the example in FIG. 8, the evaluating unit 14d calculates a difference “0.1 second” between the timing at which the person takes a beat (22.2 seconds) and the timing of a beat in the reference tempo (22.3 seconds). In this case, the evaluating unit 14d gives “Good!” and adds 1 to the score of evaluation. The evaluating unit 14d calculates a difference “0.3 second” between the timing at which the person takes a beat (23.5 seconds) and the timing of a beat in the reference tempo (23.2 seconds). In this case, the evaluating unit 14d gives “Bad!” and adds −1 to the score of evaluation. The evaluating unit 14d calculates a difference “0 second” between the timing at which the person takes a beat (24 seconds) and the timing of a beat in the reference tempo (24 seconds). In this case, the evaluating unit 14d gives “Excellent!” and adds 2 to the score of evaluation.

The evaluating unit 14d may compare timings using the timing of a beat in the reference tempo as a reference. FIG. 9 is an example diagram of a method for comparing timings in the case of using the timing of a beat in the reference tempo as a reference. The example in FIG. 9 illustrates a tempo indicated by timings at which the person takes a beat and a reference tempo. In FIG. 9, circles on the upper line indicate timings of a beat in the reference tempo, whereas circles on the lower line indicate timings at which the person takes a beat. In the example in FIG. 9, the evaluating unit 14d calculates a difference between each of the timings of a beat in the reference tempo and a timing temporally closest thereto out of the timings at which the person takes a beat. The evaluating unit 14d then calculates points corresponding to the magnitude of the difference and adds the calculated points to a score. In a case where the difference is “0” second (a first threshold), for example, the evaluating unit 14d gives “Excellent!” and adds 2 to the score of evaluation. In a case where the difference is larger than “0” second and equal to or smaller than “0.2” second (a second threshold), the evaluating unit 14d gives “Good!” and adds 1 to the score of evaluation. In a case where the difference is larger than “0.2” second, the evaluating unit 14d gives “Bad!” and adds −1 to the score of evaluation. The evaluating unit 14d calculates the difference for all the timings of a beat in the reference tempo and adds points corresponding to the difference to the score. The score is set to 0 at the start of evaluation processing. The first threshold and the second threshold are not limited to the values described above and may be set to desired values.

In the example in FIG. 9, the evaluating unit 14d calculates a difference “0.1 second” between the timing of a beat in the reference tempo (22.2 seconds) and the timing at which the person takes a beat (22.3 seconds). In this case, the evaluating unit 14d gives “Good!” and adds 1 to the score of evaluation. Because there is no timing at which the person takes a beat corresponding to the timing of a beat in the reference tempo (22.5 seconds), the evaluating unit 14d gives “Bad!” and adds −1 to the score of evaluation. The evaluating unit 14d calculates a difference “0 second” (none) between the timing of a beat in the reference tempo (23 seconds) and the timing at which the person takes a beat (23 seconds). In this case, the evaluating unit 14d gives “Excellent!” and adds 2 to the score of evaluation. Because there is no timing at which the person takes a beat corresponding to the timing of a beat in the reference tempo (23.5 seconds), the evaluating unit 14d gives “Bad!” and adds −1 to the score of evaluation. The evaluating unit 14d calculates a difference “0.2 second” between the timing of a beat in the reference tempo (24 seconds) and the timing at which the person takes a beat (23.8 seconds). In this case, the evaluating unit 14d gives “Good!” and adds 1 to the score of evaluation. In the example in FIG. 9, the timing indicated by the reference tempo used for evaluation may further include a timing between timings acquired from the sound information, that is, a timing of what is called an upbeat. This makes it possible to appropriately evaluate a rhythm of a person who takes a beat at a timing of an upbeat. It is more difficult to take an upbeat than to take a beat at a timing acquired from the sound information (a downbeat). In consideration of this, a score to be added when a timing at which the person takes a beat coincides with an upbeat may be set higher than the score to be added when the timing coincides with a downbeat.

When the evaluating unit 14d adds the points of all the timings at which the person takes a beat or the timings of all the beats in the reference tempo to the score, the evaluating unit 14d derives an evaluation using the score. The evaluating unit 14d, for example, may use the score as an evaluation without any change. Alternatively, the evaluating unit 14d may calculate scored points based on 100 points based on Equation (1) and use the scored points as an evaluation.

$$Scored Points ( Out of 100 ) = Basic Points + \frac{Value of Score}{( Number of Beats ) + Points of Excellent} \times ( 100 - Basic Points ) \qquad ( 1 )$$

In Equation (1), “basic points” represent the least acquirable points, such as 50 points. “Number of beats” represents the number of all the timings at which the person takes a beat or the number of timings of all the beats in the reference tempo. “Points of Excellent” represent “2”. In Equation (1), the denominator in the fractional term corresponds to the maximum acquirable score. In a case where all the timings are determined to be “Excellent!”, the denominator is calculated to be 100 points. Even in a case where all the timings are determined to be “Bad!”, Equation (1) provides 50 points, making it possible to maintain the motivation of the person who is dancing.

In the case of using Equation (1), the evaluating unit 14d may calculate a score such that the value of the score increases with an increase in the number of timings at which the person takes a beat with a difference from the timing indicated by the reference tempo of smaller than a predetermined value. This makes it possible to evaluate the tempo of the motion of the person in terms of whether the timing at which the person takes a beat coincides with the timing indicated by the reference tempo.

The evaluating unit 14d stores the derived evaluation in the storage unit 13 as the evaluation data 13d and transmits the evaluation to the output control unit 14e.

The output control unit 14e performs control so as to output an evaluation result, which is a result of the evaluation. The output control unit 14e, for example, transmits the evaluation result to the output unit 12 so as to output the evaluation result from the output unit 12.

The control unit 14 may be provided as a circuit, such as an application specific integrated circuit (ASIC), a field programmable gate array (FPGA), a central processing unit (CPU), and a micro processing unit (MPU).

Flow of Processing

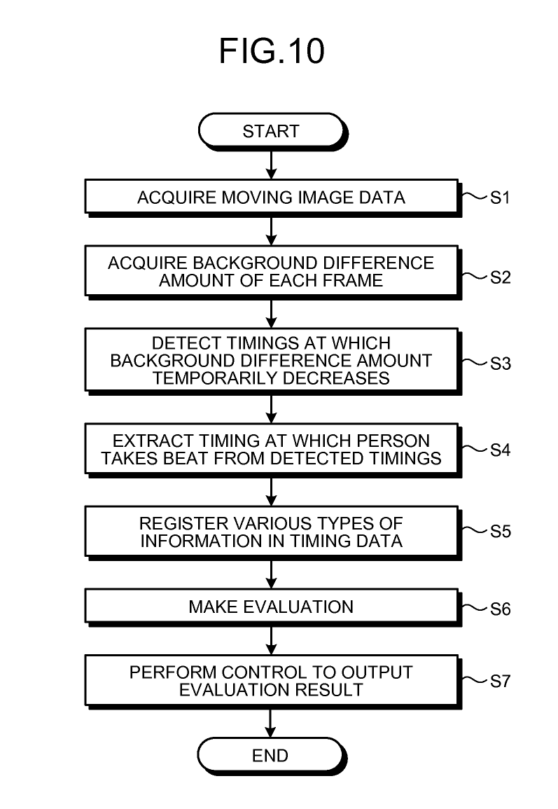

The following describes a flow of processing performed by the evaluation apparatus 10 according to the first embodiment. FIG. 10 is a flowchart of evaluation processing according to the first embodiment. The evaluation processing according to the embodiment is performed by the control unit 14 when the input unit 11 inputs an instruction to perform evaluation processing to the control unit 14, for example.

As illustrated in FIG. 10, the acquiring unit 14a acquires the moving image data 13a stored in the storage unit 13 (S1). The acquiring unit 14a acquires a background difference amount of each of a plurality of frames as a motion amount of a person and associates the background difference amount with a frame number (S2).

The detecting unit 14b detects a timing at which an amount of a temporal change in the frames obtained by sequential image capturing temporarily decreases (S3). The extracting unit 14c extracts a motion of taking a beat made by the person included in the frames or a timing at which the person takes a beat based on the timings detected by the detecting unit 14b (S4).

The extracting unit 14c registers time corresponding to a timing at which the person takes a beat out of the times of capturing the frames and “beat” in a manner associated with each other in the timing data 13b illustrated in FIG. 3. The extracting unit 14c also registers time not corresponding to a timing at which the person takes a beat out of the times of capturing the frames and “no beat” in a manner associated with each other in the timing data 13b illustrated in FIG. 3 (S5). The evaluating unit 14d makes an evaluation (S6). The output control unit 14e transmits an evaluation result to the output unit 12 so as to output the evaluation result from the output unit 12 (S7) and finishes the evaluation processing.

As described above, the evaluation apparatus 10 compares a tempo indicated by a motion of taking a beat made by a person included in a plurality of frames or a timing at which the person takes a beat, which is extracted from the frames, with a reference tempo, thereby outputting an evaluation on the tempo of the motion of the person. In other words, the evaluation apparatus 10 extracts a timing at which the person takes a beat, thereby evaluating the tempo of the motion of the person without performing recognition processing for recognizing a part of the face and the body of the person or an instrument, that is, recognition processing requiring a large amount of processing. Therefore, the evaluation apparatus 10 can facilitate evaluating the tempo of the motion of the person.

In the case of using Equation (1), the evaluation apparatus 10 calculates a score such that the value of the score increases with an increase in the number of timings at which the person takes a beat with a difference from the timing indicated by the reference tempo of smaller than a predetermined value. Therefore, the evaluation apparatus 10 can evaluate the tempo of the motion of the person in terms of whether the timing at which the person takes a beat coincides with the timing indicated by the reference tempo.

While the first embodiment evaluates whether the timing at which the person takes a beat coincides with the timing indicated by the reference tempo, the evaluation apparatus is not limited thereto. The evaluation apparatus, for example, may divide time into a plurality of sections and evaluate whether the number of timings at which the person takes a beat agrees with the number of timings indicated by the reference tempo in each section.

### [b] Second Embodiment

The following describes an embodiment that evaluates whether the number of timings at which a person takes a beat agrees with the number of timings indicated by a reference tempo in each section as a second embodiment. Components identical to those in the evaluation apparatus 10 according to the first embodiment are denoted by like reference numerals, and overlapping explanation thereof will be omitted. An evaluation apparatus 20 according to the second embodiment is different from the first embodiment in that it evaluates whether the number of timings at which the person takes a beat agrees with the number of timings indicated by the reference tempo in each section.

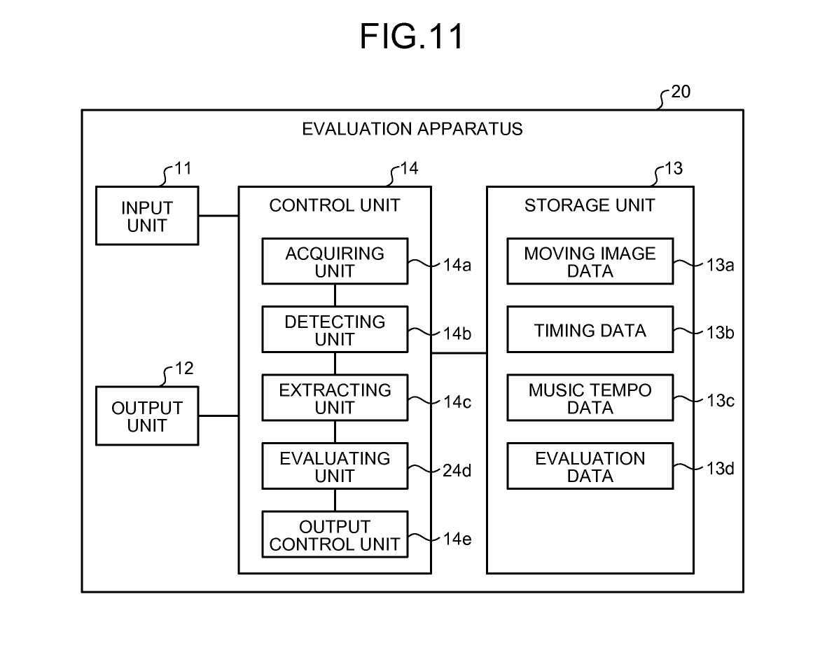

FIG. 11 is an example block diagram of a configuration of the evaluation apparatus according to the second embodiment. The evaluation apparatus 20 according to the second embodiment is different from the evaluation apparatus 10 according to the first embodiment in that it includes an evaluating unit 24d instead of the evaluating unit 14d.

The evaluating unit 24d compares a tempo indicated by a motion of taking a beat made by a person included in a plurality of frames or a timing at which the person takes a beat, which is extracted from the frames, with a reference tempo, thereby evaluating the tempo of the motion of the person. Furthermore, the evaluating unit 24d evaluates the tempo of the motion of the person based on a tempo extracted from a reproduced song (music) and on a timing at which the person takes a rhythm, which is extracted from frames including the person singing to the reproduced music as a capturing target.

An aspect of the evaluating unit 24d will be described. When the evaluating unit 24d receives registration information transmitted from the extracting unit 14c, the evaluating unit 24d acquires time of a timing at which the person takes the beat from timing data 13b.

Similarly to the evaluating unit 14d according to the first embodiment, the evaluating unit 24d acquires a reference tempo from sound information. The evaluating unit 24d stores the acquired reference tempo in the storage unit 13 as the music tempo data 13c.

The evaluating unit 24d divides time into a plurality of sections and compares the number of timings of a beat in the reference tempo indicated by the music tempo data 13c with the number of timings at which the person takes a beat acquired from the timing data 13b in each section.

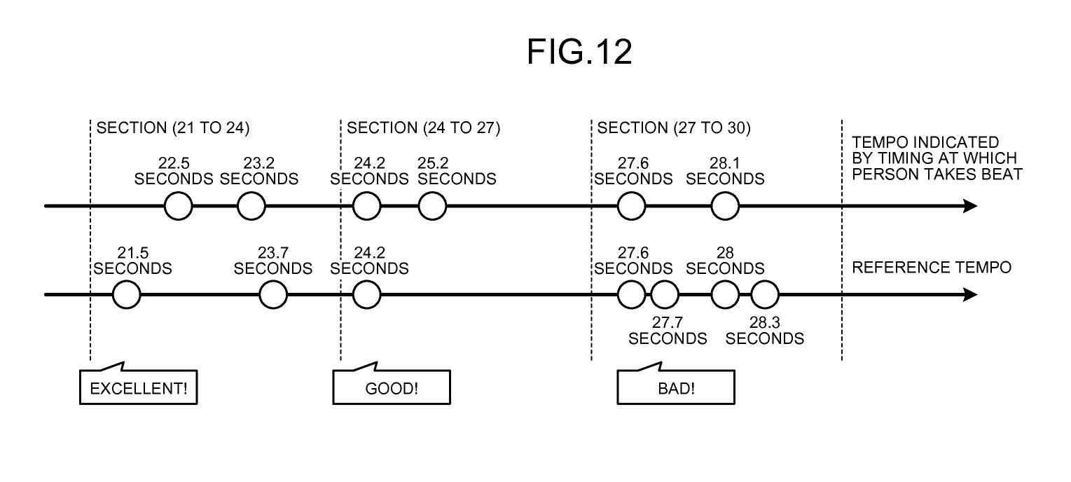

FIG. 12 is an example diagram of a method for comparing the number of timings. The example in FIG. 12 illustrates a tempo indicated by timings at which the person takes a beat and a reference tempo. In FIG. 12, circles on the upper line indicate timings at which the person takes a beat, whereas circles on the lower line indicate timings of a beat in the reference tempo. In the example in FIG. 12, the evaluating unit 24d calculates a difference between the number of timings of a beat in the reference tempo and the number of timings at which the person takes a beat in each section having a range of three seconds. The evaluating unit 24d calculates points corresponding to the magnitude of the difference and adds the calculated points to a score. In a case where the difference is “0” (a third threshold), for example, the evaluating unit 24d gives “Excellent!” and adds 2 to the score of evaluation. In a case where the difference is “1” (a fourth threshold), the evaluating unit 24d gives “Good!” and adds 1 to the score of evaluation. In a case where the difference is “2” (a fifth threshold), the evaluating unit 24d gives “Bad!” and adds −1 to the score of evaluation. The evaluating unit 24d calculates the difference in all the sections and adds points corresponding to the difference to the score. The score is set to 0 at the start of evaluation processing. The third threshold, the fourth threshold, and the fifth threshold are not limited to the values described above, and may be set to desired values.

In the example in FIG. 12, the evaluating unit 24d calculates a difference “0” between the number of timings at which the person takes a beat (22.5 seconds and 23.2 seconds) of “2” and the number of timings of a beat in the reference tempo (21.5 seconds and 23.7 seconds) of “2” in the section on and after 21 seconds and before 24 seconds. In this case, the evaluating unit 24d gives “Excellent!” and adds 2 to the score of evaluation. The evaluating unit 24d calculates a difference “1” between the number of timings at which the person takes a beat (24.2 seconds and 25.2 seconds) of “2” and the number of timings of a beat in the reference tempo (24.2 seconds) of “1” in the section on and after 24 seconds and before 27 seconds. In this case, the evaluating unit 24d gives “Good!” and adds 1 to the score of evaluation. The evaluating unit 24d calculates a difference “2” between the number of timings at which the person takes a beat (27.6 seconds and 28.1 seconds) of “2” and the number of timings of a beat in the reference tempo (27.6 seconds, 27.7 seconds, 28 seconds, and 28.3 seconds) of “4” in the section on and after 27 seconds and before 30 seconds. In this case, the evaluating unit 24d gives “Bad!” and adds −1 to the score of evaluation.

When the evaluating unit 24d adds the points of all the sections to the score, the evaluating unit 24d derives an evaluation using the score. The evaluating unit 24d, for example, may use the score as an evaluation without any change. Alternatively, the evaluating unit 24d may calculate scored points based on 100 points based on Equation (2) and use the scored points as an evaluation.

$$S cored Points ( Out of 100 ) = Basic Points + \frac{Value of Score}{( Number of Sections ) + Points of Excellent} \times ( 100 - Basic Points ) \qquad ( 2 )$$

In Equation (2), “basic points” represent the least acquirable points, such as 50 points. “Number of sections” represents the number of sections. “Points of Excellent” represent “2”. In Equation (2), the denominator in the fractional term corresponds to the maximum acquirable score. In a case where all the timings are determined to be “Excellent!”, the denominator is calculated to be 100 points. Even in a case where all the timings are determined to be “Bad!”, Equation (2) provides 50 points, making it possible to maintain the motivation of the person who is dancing.

In the case of using Equation (2), the evaluating unit 24d may calculate a score such that the value of the score increases with a decrease in the difference between the timing at which the person takes a beat and the timing indicated by the reference tempo. This makes it possible to accurately evaluate a tempo of a motion of a person who takes a beat off the rhythm of the music.

The evaluating unit 24d stores the derived evaluation in the storage unit 13 as the evaluation data 13d and transmits the evaluation to the output control unit 14e.

As described above, the evaluation apparatus 20 compares a tempo indicated by a motion of taking a beat made by a person included in a plurality of frames or a timing at which the person takes a beat, which is extracted from the frames, with a reference tempo, thereby outputting an evaluation on the tempo of the motion of the person. In other words, the evaluation apparatus 20 extracts a timing at which the person takes a beat, thereby evaluating the tempo of the motion of the person without performing recognition processing for recognizing a part of the face and the body of the person or an instrument, that is, recognition processing requiring a large amount of processing. Therefore, the evaluation apparatus 20 can facilitate evaluating the tempo of the motion of the person.

In the case of using Equation (2), the evaluation apparatus 20 may calculate a score such that the value of the score increases with a decrease in the difference between the timing at which the person takes a beat and the timing indicated by the reference tempo. This makes it possible to accurately evaluate a tempo of a motion of a person who takes a beat off the rhythm of the music, that is, a person who takes what is called an upbeat.

While the second embodiment evaluates whether the number of timings at which the person takes a beat agrees with the number of timings indicated by the reference tempo in each section, the evaluation apparatus is not limited thereto. The evaluation apparatus, for example, may evaluate whether an amount of a motion of a person matches a melody indicated by the reference tempo. The melody indicates a tone of music and is expressed by “intense” and “slow”, for example.

### [c] Third Embodiment

The following describes an embodiment that evaluates whether an amount of a motion of a person matches a melody indicated by a reference tempo in each section as a third embodiment. Components identical to those in the evaluation apparatus 10 according to the first embodiment and the evaluation apparatus 20 according to the second embodiment are denoted by like reference numerals, and overlapping explanation thereof will be omitted. An evaluation apparatus 30 according to the third embodiment is different from the first embodiment and the second embodiment in that it evaluates whether an amount of a motion of a person matches a melody indicated by the reference tempo.

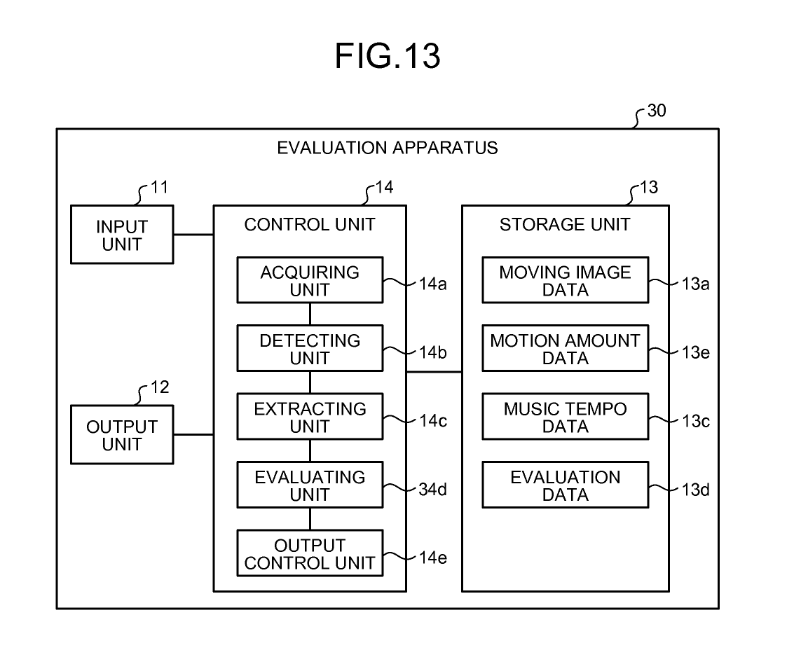

FIG. 13 is an example block diagram of a configuration of the evaluation apparatus according to the third embodiment. The evaluation apparatus 30 according to the third embodiment is different from the evaluation apparatus 20 according to the second embodiment in that it includes an evaluating unit 34d instead of the evaluating unit 24d. Furthermore, the evaluation apparatus 30 according to the third embodiment is different from the evaluation apparatus 20 according to the second embodiment in that the storage unit 13 stores therein motion amount data 13e that associates a background difference amount with a timing at which a frame is captured for each of a plurality of frames.

Besides the processing performed by the acquiring unit 14a described in the first embodiment, the acquiring unit 14a according to the third embodiment stores the motion amount data 13e that associates a background difference amount with a timing at which a frame is captured in the storage unit 13 for each of the frames.

The evaluating unit 34d evaluates whether an amount of a motion of a person indicated by the background difference amount matches a melody indicated by the reference tempo in each section.

An aspect of the evaluating unit 34d will be described. When the evaluating unit 34d receives registration information transmitted from the extracting unit 14c, the evaluating unit 34d acquires a background difference amount and a timing at which a frame is captured from the motion amount data 13e for each of a plurality of frames.

Similarly to the evaluating unit 14d according to the first embodiment, the evaluating unit 34d acquires a reference tempo from sound information. The evaluating unit 34d stores the acquired reference tempo in the storage unit 13 as the music tempo data 13c.

The evaluating unit 34d divides time into a plurality of sections and calculates the total background difference amount in each section. Because the motion of the person is assumed to be intense in sections with a total background difference amount in the top one-third of all the sections, the evaluating unit 34d associates the sections with characteristics “intense”. Because the motion of the person is assumed to be slow in sections with a total background difference amount in the bottom one-third of all the sections, the evaluating unit 34d associates the sections with characteristics “slow”. Because the motion of the person is assumed to be normal in the remaining one-third of sections of all the sections, the evaluating unit 34d associates the sections with characteristics “normal”. By associating these characteristics in this manner, it is possible to associate sections with the characteristics of intense or slow depending on each person. This can prevent variations in the evaluation result between a person who is originally active and a person who is originally inactive, for example. In other words, this can prevent variations in the evaluation result depending on differences between individuals in activity. Thus, the evaluating unit 34d sets the characteristics of the motion of the person in each section.

The evaluating unit 34d calculates the number of beats in the reference tempo in each section. Because the melody is assumed to be intense in sections with the number of beats in the top one-third of all the sections, the evaluating unit 34d associates the sections with characteristics “intense”. Because the melody is assumed to be slow in sections with the number of beats in the bottom one-third of all the sections, the evaluating unit 34d associates the sections with characteristics “slow”. Because the melody is assumed to be normal in the remaining one-third of sections of all the sections, the evaluating unit 34d associates the sections with characteristics “normal”. Thus, the evaluating unit 34d sets the characteristics of the melody in each section.

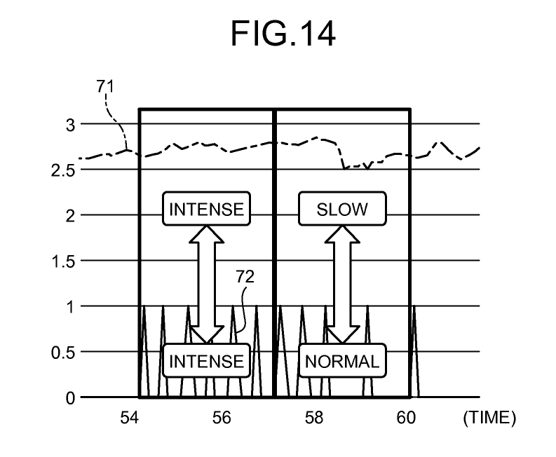

The evaluating unit 34d compares the characteristics of the motion of the person with the characteristics of the melody in all the sections. FIG. 14 is an example diagram of a method for comparing the characteristics of the motion of the person and the characteristics of the melody. The example in FIG. 14 illustrates time-series data 71 of the background difference amount and time-series data 72 of timings of beats in the reference tempo. In FIG. 14, the value of the background difference amount indicated by the time-series data 71 of the background difference amount is obtained by multiplying an actual value by 1/10000. In the time-series data 72 illustrated in FIG. 14, time with a value “1” is a timing of a beat in the reference tempo, whereas time with a value “0” is not a timing of a beat. In the example in FIG. 14, the evaluating unit 34d determines whether the characteristics of the motion of the person agree with the characteristics of the melody in each section having a range of three seconds. The evaluating unit 34d determines whether the characteristics of the motion of the person agree with the characteristics of the melody in all the sections.

In the example in FIG. 14, the evaluating unit 34d determines that the characteristics “intense” of the motion of the person agree with the characteristics “intense” of the melody in the section on and after 54 seconds and before 57 seconds. Furthermore, the evaluating unit 34d determines that the characteristics “slow” of the motion of the person do not agree with the characteristics “normal” of the melody in the section on and after 57 seconds and before 60 seconds.

When the evaluating unit 34d determines whether the characteristics of the motion of the person agree with the characteristics of the melody in all the sections, the evaluating unit 24d derives an evaluation on whether the amount of the motion of the person matches the melody indicated by the reference tempo. The evaluating unit 34d, for example, may use the number of sections where the characteristics agree as an evaluation without any change. Alternatively, the evaluating unit 34d may calculate scored points based on 100 points based on Equation (3) and use the scored points as an evaluation.

$$S cored Points ( Out of 100 ) = Basic Points + \frac{\begin{matrix}Number of Sections Where \\ Characteristics Agree\end{matrix}}{Number of All Sections} \times ( 100 - Basic Points ) \qquad ( 3 )$$

In Equation (3), “basic points” represent the least acquirable points, such as 50 points. In a case where the characteristics are determined to agree in all the sections, Equation (3) is calculated to be 100 points. Even in a case where the characteristics are determined not to agree in all the sections, Equation (3) provides 50 points, making it possible to maintain the motivation of the person who is dancing.

The evaluating unit 34d stores the derived evaluation in the storage unit 13 as the evaluation data 13d and transmits the evaluation to the output control unit 14e.

As described above, the evaluation apparatus 30 compares a motion amount of a person, which is extracted from a plurality of frames, with a reference tempo, thereby outputting an evaluation on the motion of the person. In other words, the evaluation apparatus 30 extracts a motion amount of a person, thereby evaluating the motion of the person without performing recognition processing for recognizing a part of the face and the body of the person or an instrument, that is, recognition processing requiring a large amount of processing. Therefore, the evaluation apparatus 30 can facilitate evaluating the motion of the person.

In the case of using Equation (3), the evaluation apparatus 30 may calculate a score such that the value of the score increases with an increase in the number of sections where the characteristics of the motion agree with the characteristics of the melody. This makes it possible to evaluate a motion of a person who is dancing to the melody.

While the embodiments of the disclosed apparatus have been described, the present invention may be embodied in various different aspects besides the embodiments above.

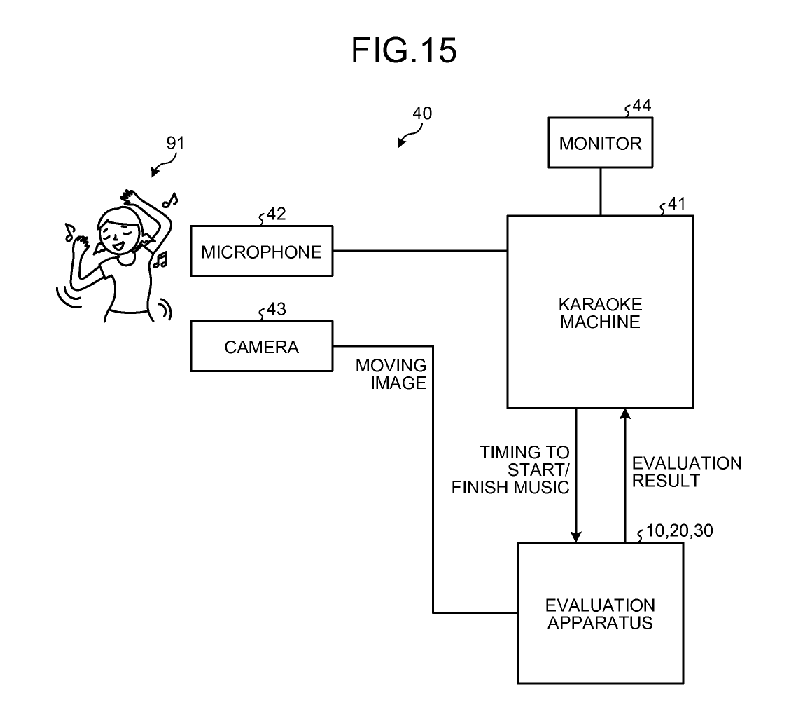

The evaluation apparatuses 10, 20, and 30 (which may be hereinafter simply referred to as an evaluation apparatus), for example, may extract a rhythm of a person in conjunction with a karaoke machine provided in a karaoke box. The evaluation apparatuses 10 and 20, for example, may extract a rhythm of a person in real time in conjunction with a karaoke machine. Extraction in real time includes an aspect in which processing is serially performed on an input frame to sequentially output a processing result, for example. FIG. 15 is an example diagram of a system in a case where the evaluation apparatus operates in conjunction with a karaoke machine. A system 40 illustrated in the example in FIG. 15 includes a karaoke machine 41, a microphone 42, a camera 43, a monitor 44, and the evaluation apparatus. The karaoke machine 41 reproduces music specified by a person 91 who performs karaoke and outputs the music from a speaker (not illustrated) for the person 91. This enables the person 91 to sing the reproduced music with the microphone 42 and dance to the music. The karaoke machine 41 transmits a message indicating that it is a timing to start reproduction of music to the evaluation apparatus at a timing to start reproduction of the music. The karaoke machine 41 also transmits a message indicating that it is a timing to finish reproduction of music to the evaluation apparatus at a timing to finish reproduction of the music.

When the evaluation apparatus receives the message indicating that it is a timing to start reproduction of music, the evaluation apparatus transmits an instruction to start image capturing to the camera 43. When the camera 43 receives the instruction to start image capturing, the camera 43 starts to capture an image of the person 91 included in an image capturing range. The camera 43 sequentially transmits frames of the moving image data 13a obtained by the image capturing to the evaluation apparatus.

Sound information including audio of the person who is singing a song and dancing to the reproduced music, which is collected by the microphone 42, and the reproduced music is sequentially transmitted to the evaluation apparatus via the karaoke machine 41. The sound information is output in parallel with the frames of the moving image data 13a.

When the evaluation apparatus receives the frames transmitted from the camera 43, the evaluation apparatus performs the various types of processing described above on the received frames. Thus, the evaluation apparatus extracts a timing at which the person 91 takes a beat and registers various types of information in the timing data 13b. The evaluation apparatus may perform the various types of processing described above on the received frames, thereby generating the motion amount data 13e. When the evaluation apparatus receives the sound information from the karaoke machine 41, the evaluation apparatus acquires the reference tempo from the received sound information. The evaluation apparatus then performs the evaluation described above and transmits the evaluation result to the karaoke machine 41.

When the karaoke machine 41 receives the evaluation result, the karaoke machine 41 displays the received evaluation result on the monitor 44. This enables the person 91 to grasp the evaluation result. In a case where the evaluation apparatus is the evaluation apparatus 10 or the evaluation apparatus 20, it is possible to display the evaluation result on the monitor 44 in real time. Thus, in the case where the evaluation apparatus is the evaluation apparatus 10 or the evaluation apparatus 20, the system 40 can quickly output the evaluation result.

When the evaluation apparatus receives the message indicating that it is a timing to finish reproduction of music from the karaoke machine 41, the evaluation apparatus transmits an instruction to stop image capturing to the camera 43. When the camera 43 receives the instruction to stop image capturing, the camera 43 stops image capturing.

As described above, the evaluation apparatus in the system 40 can output the evaluation result in conjunction with the karaoke machine 41 provided in the karaoke box.

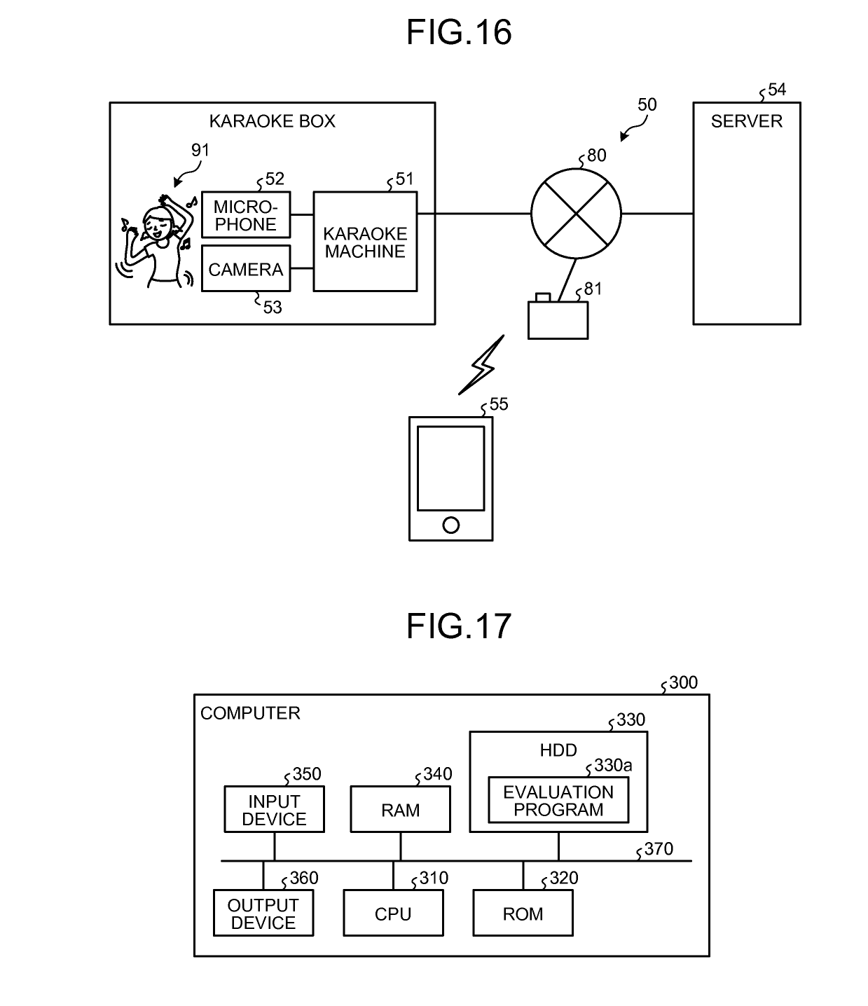

A server provided outside of the karaoke box may have the same functions as the various types of functions of the evaluation apparatus and output an evaluation result. FIG. 16 is an example diagram of a system including a server. A system 50 illustrated in the example in FIG. 16 includes a karaoke machine 51, a microphone 52, a camera 53, a server 54, and a mobile terminal 55. The karaoke machine 51 reproduces music specified by the person 91 who performs karaoke and outputs the music from a speaker (not illustrated) for the person 91. This enables the person 91 to sing the reproduced music with the microphone 52 and dance to the music. The karaoke machine 51 transmits an instruction to start image capturing to the camera 53 at a timing to start reproduction of the music. The karaoke machine 51 also transmits an instruction to stop image capturing to the camera 53 at a timing to finish reproduction of the music.

When the camera 53 receives the instruction to start image capturing, the camera 53 starts to capture an image of the person 91 included in an image capturing range. The camera 53 sequentially transmits frames of the moving image data 13a obtained by the image capturing to the karaoke machine 51. When the karaoke machine 51 receives the frames transmitted from the camera 53, the karaoke machine 51 sequentially transmits the received frames to the server 54 via a network 80. Furthermore, the karaoke machine 51 sequentially transmits sound information including audio of the person who is singing a song and dancing to the reproduced music, which is collected by the microphone 52, and the reproduced music to the server 54 via the network 80. The sound information is output in parallel with the frames of the moving image data 13a.

The server 54 performs processing similar to the various types of processing performed by the evaluation apparatus described above on the frames transmitted from the karaoke machine 51. Thus, the server 54 extracts a timing at which the person 91 takes a beat and registers various types of information in the timing data 13b. The server 54 may perform the various types of processing described above on the received frames, thereby generating the motion amount data 13e. When the server 54 receives the sound information from the karaoke machine 51, the server 54 acquires the reference tempo from the received sound information. The server 54 then performs the evaluation described above and transmits the evaluation result to the mobile terminal 55 of the person 91 via the network 80 and a base station 81.

When the mobile terminal 55 receives the evaluation result, the mobile terminal 55 displays the received evaluation result on its display. This enables the person 91 to grasp the evaluation result on the mobile terminal 55 of the person 91.

The processing at each step in the processing described in the embodiments may be optionally distributed or integrated depending on various types of loads and usage, for example. Furthermore, a step may be omitted.

The order of processing at each step in the processing described in the embodiments may be changed depending on various types of loads and usage, for example.

The components of each apparatus illustrated in the drawings are functionally conceptual and are not necessarily physically configured as illustrated. In other words, the specific aspects of distribution and integration of each apparatus are not limited to those illustrated in the drawings. All or a part of the components may be distributed or integrated functionally or physically in desired units depending on various types of loads and usage, for example. The camera 43 according to the embodiment may be connected to the karaoke machine 41 to be made communicable with the evaluation apparatus via the karaoke machine 41, for example. Furthermore, the functions of the karaoke machine 41 and the evaluation apparatus according to the embodiment may be provided by a single computer, for example.

Evaluation Program

The various types of processing performed by the evaluation apparatuses 10, 20, and 30 described in the embodiments may be performed by a computer system, such as a personal computer and a workstation, executing a computer program prepared in advance. The following describes an example of a computer that executes an evaluation program having functions similar to those of the evaluation apparatus according to any one of the first to the third embodiments with reference to FIG. 17. FIG. 17 is a diagram of a computer that executes the evaluation program.

As illustrated in FIG. 17, a computer 300 includes a CPU 310, a read only memory (ROM) 320, a hard disk drive (HDD) 330, a random access memory (RAM) 340, an input device 350, and an output device 360. These devices 310, 320, 330, 340, 350, and 360 are connected via a bus 370.

The ROM 320 stores therein a basic program such as an operating system (OS). The HDD 330 stores therein in advance an evaluation program 330a that exerts functions similar to those of the accruing unit 14a, the detecting unit 14b, the extracting unit 14c, the evaluating unit 14d, 24d, or 34d, and the output control unit 14e described in the embodiments. The HDD 330 stores therein in advance the moving image data 13a, the timing data 13b, the music tempo data 13c, the evaluation data 13d, and the motion amount data 13e.

The CPU 310 reads and executes the evaluation program 330a from the HDD 330. The CPU 310 reads the moving image data 13a, the timing data 13b, the music tempo data 13c, the evaluation data 13d, and the motion amount data 13e from the HDD 330 and stores these data in the RAM 340. The CPU 310 uses the various types of data stored in the RAM 340, thereby executing the evaluation program 330a. All the data stored in the RAM 340 are not always stored in the RAM 340. Only data used for processing may be stored in the RAM 340.

The evaluation program 330a is not necessarily stored in the HDD 330 from the first. The evaluation program 330a, for example, is stored in a “portable physical medium” inserted into the computer 300, such as a flexible disk (FD), a compact disc read only memory (CD-ROM), a digital versatile disc (DVD), a magneto-optical disc, and an integrated circuit (IC) card. The computer 300 may read and execute the evaluation program 330a from the medium.

Alternatively, the evaluation program 330a is stored in “another computer (or a server)” connected to the computer 300 via a public line, the Internet, a local area network (LAN), and a wide area network (WAN), for example. The computer 300 may read and execute the evaluation program 330a from the computer or the server.

The embodiments can evaluate a tempo of a motion of a person from a captured image.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute an evaluation process comprising:
acquiring a beat or a timing at which a person included in a plurality of captured images obtained by sequential image capturing takes a beat, motion or timing being extracted from the plurality of captured images; and
outputting an evaluation on a tempo of a motion of the person based on a comparison of a tempo indicated by the acquired beat or the acquired timing with a reference tempo.

2. The non-transitory computer-readable recording medium according to claim 1, wherein the reference tempo includes a tempo acquired based on sound information output in parallel with the captured images.

3. The non-transitory computer-readable recording medium according to claim 1, wherein the evaluation process further includes performing control such that a score of the evaluation increases with an increase in number of the extracted timings with a difference from a timing indicated by the reference tempo of smaller than a predetermined value.

4. The non-transitory computer-readable recording medium according to claim 1, wherein the evaluation process further includes performing control such that a score of the evaluation increases with a decrease in a difference between the tempo indicated by the extracted timing and the reference tempo.

5. An evaluation method comprising:
acquiring a beat or a timing at which a person included in a plurality of captured images obtained by sequential image capturing takes a beat, motion or timing being extracted from the plurality of captured images; and
outputting an evaluation on a tempo of a motion of the person based on a comparison of a tempo indicated by the acquired beat or the acquired timing with a reference tempo.

6. An evaluation apparatus comprising:
a processor that executes a process including:
acquiring a beat or a timing at which a person included in a plurality of captured images obtained by sequential image capturing takes a beat, motion or timing being extracted from the plurality of captured images; and
outputting an evaluation on a tempo of a motion of the person based on a comparison of a tempo indicated by the acquired beat or the acquired timing with a reference tempo.

7. A non-transitory computer-readable recording medium having stored therein a program that causes a computer to execute an evaluation process comprising:
making an evaluation on a motion of a person who is singing in accordance with reproduced music based on a tempo extracted from the reproduced music and a timing at which the person who is singing takes a beat, the timing being acquired from captured images including the person who is singing as a capturing target; and
outputting a result of the evaluation.

8. An evaluation method comprising:
making an evaluation on a motion of a person who is singing in accordance with reproduced music based on a tempo extracted from the reproduced music and a timing at which the person who is singing takes a beat, the timing being acquired from captured images including the person who is singing as a capturing target, using a processor; and
outputting a result of the evaluation, using the processor.

9. An evaluation apparatus comprising:
a processor that executes a process including:
making an evaluation on a motion of a person who is singing in accordance with reproduced music based on a tempo extracted from the reproduced music and a timing at which the person who is singing takes a beat, the timing being acquired from captured images including the person who is singing as a capturing target; and
outputting a result of the evaluation.
